(19) United States
(12) Patent Application Publication
(10) Pub. No.: US 2011/0018875 A1
(43) Pub. Date: Jan. 27, 2011

(54) IMAGE PROCESSING DEVICE, IMAGE PROCESSING DEVICE CONTROL METHOD, PROGRAM, AND INFORMATION STORAGE MEDIUM

(75) Inventors: Keiichiro Arahari, Minato-ku (JP); Ryuma Hachisu, Minato-ku (JP); Yoshihiko Sato, Minato-ku (JP)

Correspondence Address: SUGHRUE MION, PLLC, 2100 PENNSYLVANIA AVENUE, N.W., SUITE 800, WASHINGTON, DC, 20037, US

(73) Assignee: Konami Digital Entertainment Co., Ltd.

(21) Appl. No.: 12/933,771

(22) PCT Filed: Mar. 4, 2009
(86) PCT No.: PCT/JP2009/054023

§ 371 Date: Sep. 21, 2010

(30) Foreign Application Priority Data
Mar. 24, 2008 (JP) 2008-076348

(51) Int. Cl. G06T 17/00

(52) U.S. Cl. 345/420

(57) ABSTRACT

To provide an image processing device capable of assisting a user to readily recognize bumps and recesses of an object. An original texture image storage unit (82) stores an original texture image for an object. A second display control unit (88) displays, on a display unit, an image showing a picture obtained by viewing an object having an auxiliary-lined texture image mapped thereon from a viewpoint, the auxiliary-lined texture image being formed by drawing a plurality of auxiliary lines forming a mesh or a plurality of parallel auxiliary lines on an original texture image.

### TECHNICAL FIELD

The present invention relates to an image processing device, an image processing device control method, a program, and an information storage medium.

### BACKGROUND ART

There is known an image processing device for displaying an image showing a picture obtained by viewing an object placed in a virtual three dimensional space from a given viewpoint. For example, in a game device (an image processing device) in which a soccer game is carried out, a game screen image showing a picture obtained by viewing from a viewpoint a virtual three dimensional space where a player object representative of a soccer player, or the like, is placed is displayed.

### [Patent Document 1] JP 2006-110218 A

### DISCLOSURE OF THE INVENTION

### Problems to be Solved by the Invention

In the above described image processing device, there may arise a need for assisting a user to readily recognize bumps and recesses of an object. For example, as a game device for carrying out the above described soccer game, there is known a game device having a deforming function for allowing a user to change the shape of the face, or the like, of a player object. In changing the shape of a player object, generally, a user wishes to change the shape of the player object while checking the changing state of bumps and recesses formed on the player object. For this purpose, in realizing the above described deforming function, it is necessary to have an arrangement that assists a user to readily recognize a changing state of bumps and recesses formed on a player object.

The present invention has been conceived in view of the above, and aims to provide an image processing device, an image processing device control method, a program, and an information storage medium capable of assisting a user to readily recognize bumps and recesses of an object.

### Means for Solving the Problems

In order to achieve the above described object, an image processing device according to the present invention is an image processing device for displaying an image showing a picture obtained by viewing an object placed in a virtual three dimensional space from a given viewpoint, comprising: original texture image storage means for storing an original texture image for the object; and display control means for displaying, on display means, an image showing a picture obtained by viewing, from the viewpoint, an object having an auxiliary-lined texture image mapped thereon, the auxiliary-lined texture image being formed by drawing a plurality of auxiliary lines forming a mesh or a plurality of parallel auxiliary lines on the original texture image.

An image processing device control method according to the present invention is a control method for controlling an image processing device for displaying an image showing a picture obtained by viewing an object placed in a virtual three dimensional space from a given viewpoint, the method comprising: a step of reading content stored in original texture image storage means for storing an original texture image for the object; and a display control step of displaying, on display means, an image showing a picture obtained by viewing, from the viewpoint, an object having an auxiliary-lined texture image mapped thereon, the auxiliary-lined texture image being formed by drawing a plurality of auxiliary lines forming a mesh or a plurality of parallel auxiliary lines on the original texture image.

A program according to the present invention is a program for causing a computer to function as an image processing device for displaying an image showing a picture obtained by viewing an object placed in a virtual three dimensional space from a given viewpoint, the program for causing the computer to function as: original texture image storage means for storing an original texture image for the object; and display control means for displaying, on display means, an image showing a picture obtained by viewing, from the viewpoint, an object having an auxiliary-lined texture image mapped thereon, the auxiliary-lined texture image being formed by drawing a plurality of auxiliary lines forming a mesh or a plurality of parallel auxiliary lines on the original texture image.

An information storage medium according to the present invention is a computer readable information storage medium storing the above described program. A program distribution device according to the present invention is a program distribution device having an information storage medium storing the above described program, for reading the program from the information storage medium and distributing the program. A program distribution method according to the present invention is a program distribution method for reading the program from an information storage medium storing the above described program, and distributing the program.

The present invention relates to an image processing device for displaying an image showing a picture obtained by viewing an object placed in a virtual three dimensional space from a given viewpoint. According to the present invention, an original texture image for an object is stored. According to the present invention, an image showing a picture obtained by viewing, from the viewpoint, an object having an auxiliary-lined texture image mapped thereon is displayed on display means, the auxiliary-lined texture image being formed by drawing a plurality of auxiliary lines forming a mesh or a plurality of parallel auxiliary lines on the original texture image. According to the present invention, it is possible to have an arrangement to assist a user to be able to readily recognize bumps and recesses of an object.

According to one aspect of the present invention, the display control means may include auxiliary-lined texture image obtaining means for obtaining the auxiliary-lined texture image, and the display control means may display, on the display means, an image showing a picture obtained by viewing, from the viewpoint, the object having the auxiliary-lined texture image mapped thereon, the auxiliary-lined texture image being obtained by the auxiliary-lined texture image obtaining means.

According to one aspect of the present invention, the auxiliary-lined texture image obtaining means may produce the auxiliary-lined texture image, based on the original texture image.

According to one aspect of the present invention, the auxiliary-lined texture image obtaining means may draw the plurality of auxiliary lines forming a mesh or the plurality of parallel auxiliary lines on the original texture image to thereby produce the auxiliary-lined texture image.

According to one aspect of the present invention, the auxiliary-lined texture image obtaining means may draw at least a plurality of first auxiliary lines parallel to one another and a plurality of second auxiliary lines parallel to one another and intersecting the plurality of first auxiliary lines on the original texture image to thereby produce the auxiliary-lined texture image.

According to one aspect of the present invention, the display control means may include means for controlling fineness of the mesh or an interval of the plurality of auxiliary lines for each of a plurality of areas set on the auxiliary-lined texture image.

According to one aspect of the present invention, the display control means may include means for controlling fineness of the mesh or an interval of the plurality of auxiliary lines, based on a position of the viewpoint.

According to one aspect of the present invention, the display control means may include means for controlling the color of the plurality of auxiliary lines forming a mesh or the plurality of parallel auxiliary lines, based on the original texture image.

### BRIEF DESCRIPTION OF THE DRAWINGS

FIG. 1 is a diagram showing a hardware structure of a game device according to the present embodiment;

FIG. 2 is a diagram showing one example of a virtual three dimensional space;

FIG. 3 is a diagram showing one example of external appearance of the head portion of a player object;

FIG. 4 is a diagram showing a wire frame of the head portion of a player object;

FIG. 5 is a diagram showing one example of a face texture image;

FIG. 6 is a diagram showing one example of a face deforming screen image;

FIG. 7 is a functional block diagram of a game device according to the present embodiment;

FIG. 8 is a diagram showing one example of an auxiliary-lined face texture image;

FIG. 9 is a diagram showing another example of a virtual three dimensional space;

FIG. 10 is a diagram showing one example of interval control data;

FIG. 11 is a flowchart of a process carried out in the game device;

FIG. 12 is a diagram showing another example of an auxiliary-lined face texture image; and

FIG. 13 is a diagram showing an overall structure of a program distribution system according to another embodiment of the present invention.

### BEST MODE FOR CARRYING OUT THE INVENTION

In the following, one example of an embodiment of the present invention will be described in detail with reference to the accompanying drawings. In the following, a case in which the present invention is applied to a game device, which is one aspect of an image processing device, will be described. A game device according to an embodiment of the present invention is realized, using, e.g., a consumer game device (an installation game device), a portable game device, a portable phone, a personal digital assistant (PDA), a personal computer, or the like. In the following, a case in which a game device according to an embodiment of the present invention is realized using a consumer game device will be described. However, the present invention is applicable to other image processing devices (e.g., a personal computer).

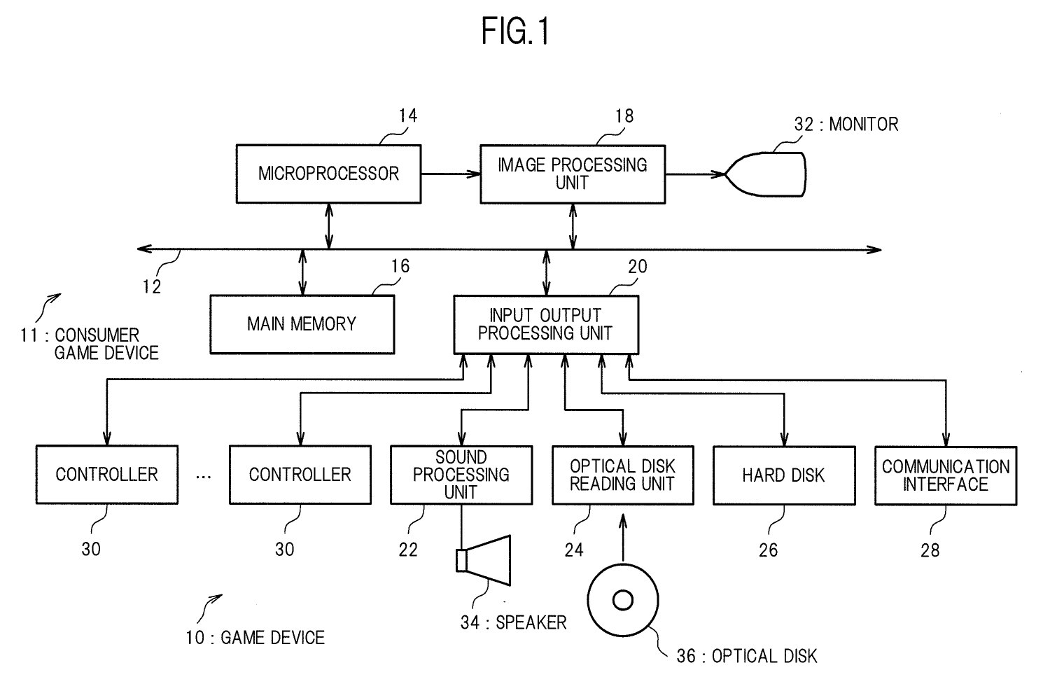

FIG. 1 is a diagram showing an overall structure of a game device according to an embodiment of the present invention. The game device 10 shown in FIG. 1 comprises a consumer game device 11, a monitor 32, a speaker 34, and an optical disk 36 (an information storage medium). The monitor 32 and the speaker 34 are connected to the consumer game device 11. As a monitor 32, for example, a home-use television set receiver is used; as a speaker 34, for example, a speaker built in to a home-use television set receiver is used.

The consumer game device 11 is a publicly known computer game system. The consumer game device 11 comprises a bus 12, a microprocessor 14, a main memory 16, an image processing unit 18, an input output processing unit 20, a sound processing unit 22, an optical disk reading unit 24, a hard disk 26, a communication interface 28, and a controller 30. Structural elements other than the controller 30 are accommodated in an enclosure of the consumer game device 11.

The microprocessor 14 controls the respective units of the portable game device 10, based on an operating system stored in a ROM (not shown) and a program read from the optical disk 36 or the hard disk 26. The main memory 16 comprises, for example, a RAM. A program and data read from the optical disk 36 or the hard disk 26 is written into the main memory 16 when necessary. The main memory 16 is used also as a working memory of the microprocessor 14. The bus 12 is used to exchange an address and data among the respective units of the consumer game device 11. The microprocessor 14, the main memory 16, the image processing unit 18, and the input output processing unit 20 are connected via the bus 12 for data exchange.

The image processing unit 18 includes a VRAM, and renders a game screen image into the VRAM, based on image data sent from the microprocessor 14. The image processing unit 18 converts a game screen image rendered in the VRAM into a video signal, and outputs to the monitor 32 at a predetermined time.

The input output processing unit 20 is an interface via which the microprocessor 14 accesses the sound processing unit 22, the optical disk reading unit 24, the hard disk 26, the communication interface 28, and the controller 30. The sound processing unit 22 has a sound buffer, and reproduces and outputs via the speaker 34 various sound data, including game music, game sound effects, a message, and so forth, read from the optical disk 36 or the hard disk 26. The communication interface 28 is an interface for connecting the consumer game device 11 to a communication network, such as the Internet, or the like, in either a wired or wireless manner.

The optical disk reading unit 24 reads a program and data recorded on the optical disk 36. Note that although the optical disk 36 is used here to provide a program and data to the consumer game device 11, any other information storage medium, such as a memory card, or the like, may be used. Alternatively, a program and data may be supplied via a communication network, such as the Internet or the like, from a remote place to the consumer game device 11. The hard disk 26 is a typical hard disk (an auxiliary memory device). Note that the game device 10 may have a memory card slot for reading data from a memory card and writing data into the memory card.

The controller 30 is a general purpose operation input means on which a user inputs various game operations. The consumer game device 11 is adapted for connection to a plurality of controllers 30. The input output processing unit 20 scans the state of the controller 30 every constant cycle (e.g., every 1/60^{th} of a second) and forwards an operating signal describing a scanning result to the microprocessor 14 via the bus 12, so that the microprocessor 14 can determine a game operation carried out by a game player, based on the operating signal. Note that the controller 30 may be connected in either a wired or wireless manner to the consumer game device 11.

In the game device 10, for example, a soccer game is carried out. A soccer game is realized by carrying out a program read from the optical disk 36.

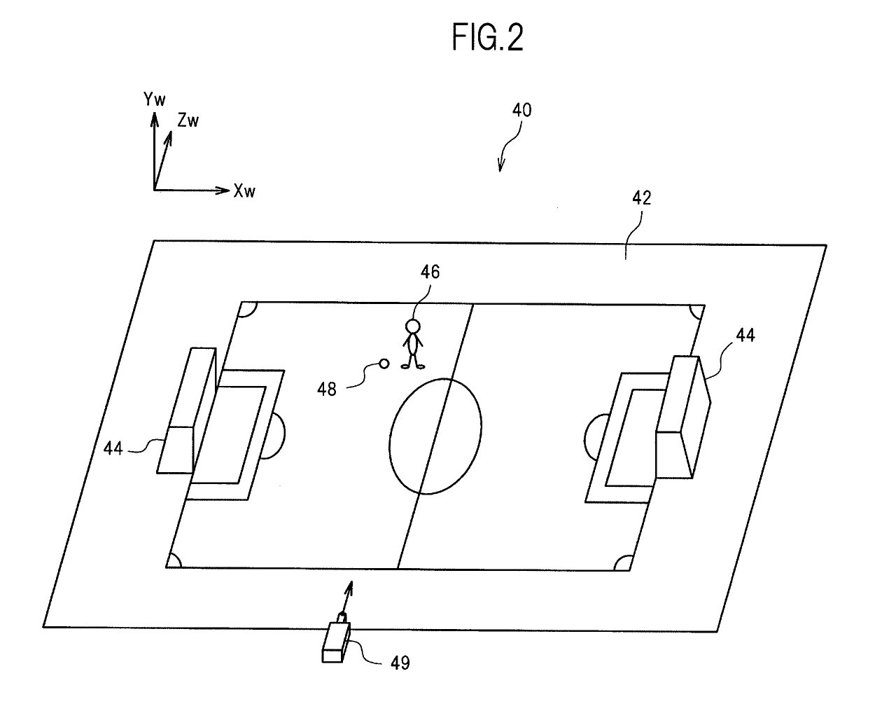

In the main memory 16, a virtual three dimensional space is created. FIG. 2 shows one example of a virtual three dimensional space. As shown in FIG. 2, a field object 42 representing a soccer field is placed in the virtual three dimensional space 40. A goal object 44 representing a goal, a player object 46 representing a soccer player, and a ball object 48 representing a soccer ball are placed on the field object 42. Although omitted in FIG. 2, twenty-two player objects 46 are placed on the field object 42. Each object is shown in a simplified manner in FIG. 2.

An object, such as a player object 46 or the like, comprises a plurality of polygons, and has a texture image mapped thereon. A point of an object (a vertex, or the like, of a polygon) is correlated to a point (pixel) on a texture image, and the color of each point of an object is controlled, based on the color of the correlated point on the texture image.

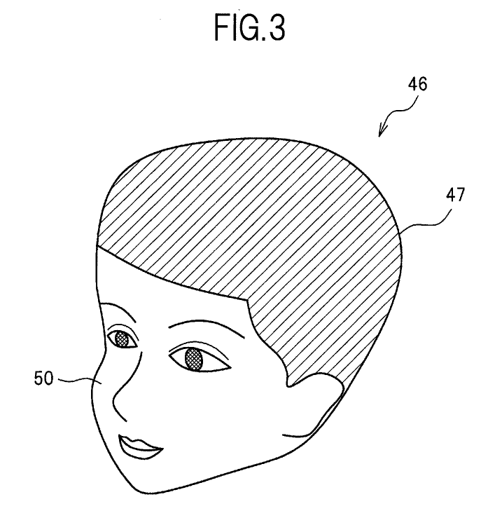

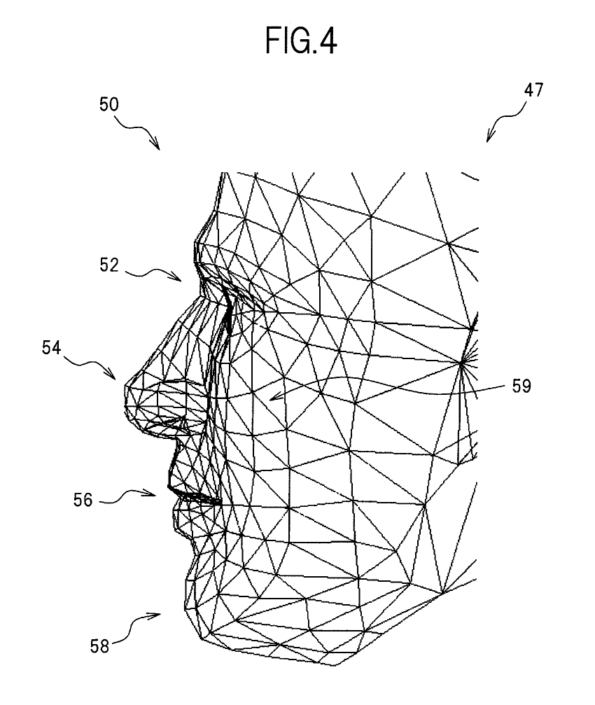

FIG. 3 is a diagram showing one example of external appearance of the head portion 47 of a player object 46, and FIG. 4 is a diagram showing a wire frame of the head portion 47 (face 50) of a player object 46. That is, FIG. 4 is a diagram showing one example of polygons forming the head portion 47 (face 50) of a player object 46. As shown in FIG. 4, using a plurality of polygons, bumps and recesses for an eye 52, a nose 54, a mouth 56, a jaw 58, a cheek 59, and so forth, are formed. A texture image representing the face (an eye, a nose, a mouth, skin, and so forth) of a soccer player (hereinafter referred to as a “face texture image”) is mapped on the polygons forming the face 50. FIG. 5 shows one example of a face texture image. On the face texture image 60 shown in FIG. 5, for example, an eye 62, a nose 64, a mouth 66, and so forth are drawn. Note that although not shown in FIG. 5, for example, an ear, or the like, of a soccer player is additionally drawn on the face texture image 60. Apart of the face texture image 60, corresponding to, for example, the eye 62 is correlated to, and mapped on, the polygons forming the eye 52 of the player object 46.

Note that a virtual camera 49 (a viewpoint) is set in the virtual three dimensional space 40. The virtual camera 49 moves within the virtual three dimensional space 40, based on, for example, movement of the ball object 48. A game screen image (hereinafter referred to as “a main game screen image”) showing a picture obtained by viewing the virtual three dimensional space 40 from the virtual camera 49 is displayed on the monitor 32. A user operates a player object 46 while looking at a main game screen image, trying to score for their own team.

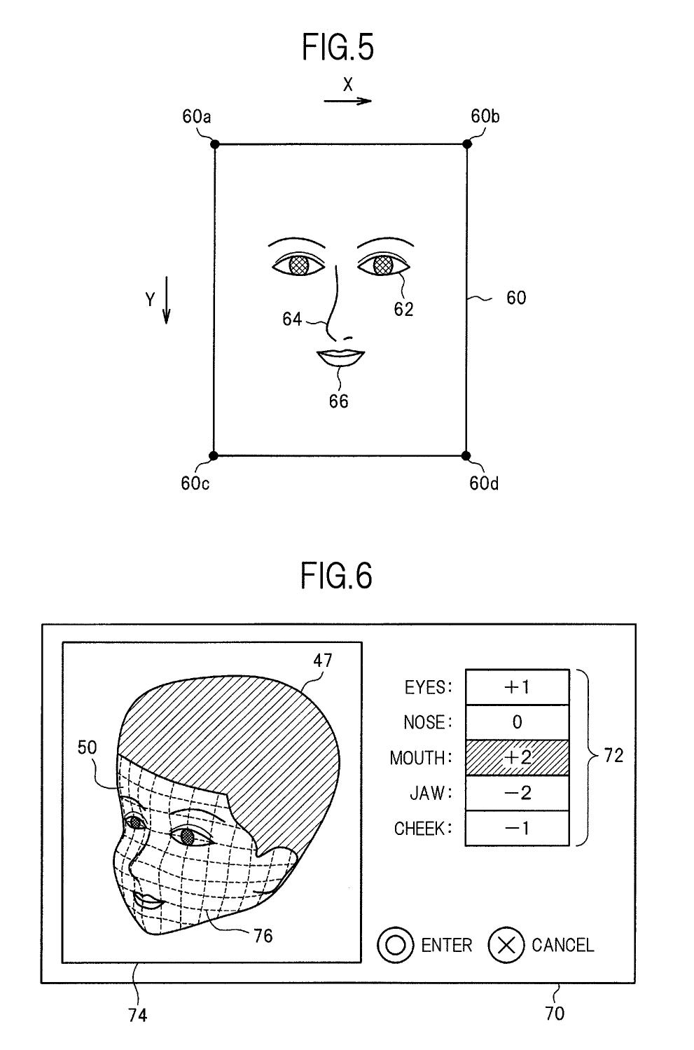

A soccer game according to the present embodiment has a face deforming function, using which a user can desirably change the face 50 of a player object 46. FIG. 6 shows one example of a face deforming screen image. The face deforming screen image 70 shown in FIG. 6 has a deforming parameter space 72 and a deformed result space 74.

The deforming parameter space 72 is a space in which for a user to set a parameter (hereinafter referred to as a “deforming parameter”) concerning deforming of the face 50 of a player object 46. In the face deforming screen image 70 shown in FIG. 6, five kinds of deforming parameters, namely, “eye”, “nose”, “mouth”, “jaw”, and “cheek”, can be set. The “eye”, “nose”, “mouth”, and “cheek” parameters are parameters for controlling the size, shape, and so forth, of the eye 52, nose 54, mouth 56, and cheek 59 of a player object 46, respectively, and the “jaw” parameter is a parameter for controlling the length, or the like, of the jaw 58 of a player object 46. In the following, the “eye” parameter will be mainly described in detail, though the description similarly applies to the “nose”, “mouth”, “jaw”, and “cheek” parameters.

For example, the “eye” parameter shows a value indicating an extent by which the size of the eye 52 of a player object 46 is enlarged or reduced from the initial size thereof, and takes an integer between, e.g., −3 and +3. Based on the “eye” parameter value, the positions of vertexes of polygons forming the eye 52 of a player object 46 are determined. More specifically, the positions of vertexes of polygons forming the eye 52 corresponding to cases of respective integers between −3 and +3 are predetermined. If the “eye” parameter value is 0, the positions of vertexes of polygons forming the eye 52 are determined such that the eye 52 has the initial size. If the “eye” parameter has a positive value, the positions of vertexes of polygons forming the eye 52 are determined such that the eye 52 has a size larger than the initial size thereof. In this case, the positions of vertexes of polygons forming the eye 52 are determined such that an eye 52 larger in size results from a larger “eye” parameter value. Meanwhile, if the “eye” parameter has a negative value, the positions of vertexes of polygons forming the eye 52 are determined such that the eye 52 has a size smaller than the initial size thereof. In this case, the positions of vertexes of polygons forming the eye 52 are determined such that an eye 62 smaller in size results from a smaller “eye” parameter value.

In the face deforming screen image 70, a user initially designates either an upper or lower direction to thereby select a deforming parameter to change. The deforming parameter selected to be changed is distinctly displayed. In the example shown in FIG. 6, the “mouth” parameter is being distinctly displayed. After selection of a deforming parameter to be changed, a user designates either a right or left direction to thereby increase/decrease the value of the deforming parameter to be changed.

In the deformed result space 74, the image of the head portion 47 (face 50) of a player object 46, corresponding to the result of the deforming parameter having been changed is displayed. That is, an image showing the shape of the head portion 47 of a player object 46 which results with the respective deforming parameters set to the values displayed in the deforming parameter space 72 is displayed in the deformed result space 74. If a user increases/decreases a deforming parameter value, the image of the head portion 47 of the player object 46 displayed in the deformed result space 74 is accordingly updated. A user can desirably enlarge or reduce the size of the head portion 47 of the player object 46 displayed in the deformed result space 74 by instructing enlargement or size reduction.

A user can check the result of the face 50 of the player object 46 having been changed, by referring to the deformed result space 74. In the deformed result space 74, in particular, auxiliary lines 76 for assisting a user to readily recognize bumps and recesses are shown on the face 50 of the player object 46. In the example shown in FIG. 6, a line corresponding to the portrait direction of the face 50 of the player object 46 and a line corresponding to the landscape direction of the same are displayed as auxiliary lines 76. A mesh formed by these auxiliary lines 76 is shown on the face 50 of the player object 46. The shape of the mesh is changed (a manner in which the auxiliary line 76 is bent, and so forth) when bumps and recesses formed on the face 50 of the player object 46 are changed as a user changes a deforming parameter value. Therefore, a user can readily recognize bumps and recesses formed on the face 50 of the player object 46, by referring to the state of the mesh (the auxiliary lines 76). For example, by referring to the shape of the mesh being changed, a user can understand at a glance bumps and recesses on the face 50, which are changing as a result of changing a deforming parameter.

If a deforming process is completed in the face deforming screen image 70, a user presses an enter button. If the enter button is pressed, deforming parameter data and deformed shape data are stored in the hard disk 26 (or a memory card). Deforming parameter data is data indicating a result of setting a deforming parameter, that is, a data indicating the value shown in the deforming parameter space 72 when the enter button is pressed. Deformed shape data is data expressing the shape of the head portion 47 (face 50) of the player object 46 having been deformed as instructed by a user, that is, data indicating the position coordinates of vertexes of polygons forming the head portion 47 of the player object 46 having been deformed as instructed by a user. To display, for example, a main game screen image, deformed shape data (or deforming parameter data) is read, and the shape of the head portion 47 (face 50) of a player object 46 placed in the virtual three dimensional space 40 is controlled, based on the deformed shape data (or the deforming parameter data). As a result, a player object 46 having a face 50 deformed as instructed by a user is shown in the main game screen image.

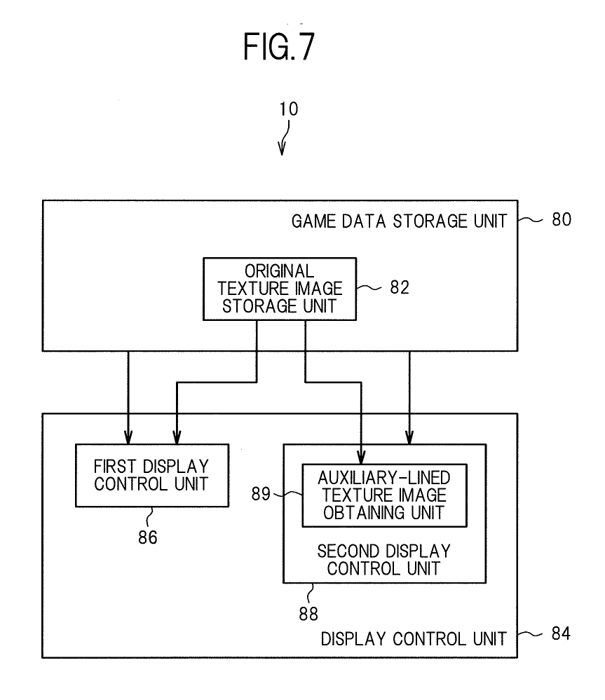

Below, a structure for realizing the above-described face deforming function will be described. FIG. 7 is a functional block diagram mainly showing a functional block related to the face deforming function among the functional blocks realized in the game device. As shown in FIG. 7, the game device 10 comprises a game data storage unit 80 and a display control unit 84. These functional blocks are realized by the microprocessor 14 carrying out a program.

The game data storage unit 80 is realized using, for example, the main memory 16, the hard disk 26, and the optical disk 36. The game data storage unit 80 stores various data for carrying out a soccer game, such as, for example, data describing the states (position, posture, and so forth) of the virtual camera 49 and respective objects placed in the virtual three dimensional space 40. Further, for example, data describing the shape of each object is stored in the game data storage unit 80.

The game data storage unit 80 includes an original texture image storage unit 82 for storing a texture image of an object, such as, for example, a face texture image 60 (see FIG. 5) for a player object 46. Note that for distinction from an “auxiliary-lined texture image”, to be described later, a face texture image 60, or the like, stored in the original texture image storage unit 82 will be hereinafter referred to as an “original texture image”.

The display control unit 84 is realized mainly using the microprocessor 14 and the image processing unit 18. The display control unit 84 displays various screen images on the monitor 32, based on various data stored in the game data storage unit 80.

The display control unit 84 includes a first display control unit 86 for displaying, on the monitor 32, an image showing a picture obtained by viewing an object with an original texture image mapped intact thereon from a given viewpoint. In the present embodiment, the first display control unit 86 displays on the monitor 32 a main game screen image showing a picture obtained by viewing the virtual three dimensional space 40 from the virtual camera 49. In a main game screen image, a player object 46 with a face texture image 60 mapped intact thereon is shown.

The display control unit 84 additionally includes a second display control unit 88 for displaying, on the monitor 32, an image showing a picture obtained by viewing an object with an auxiliary-lined texture image mapped intact thereon from a given viewpoint. An auxiliary-lined texture image refers to a texture image formed by drawing on an original texture image auxiliary lines 76 for assisting a user to readily recognize bumps and recesses of an object, with details thereof being described later.

In the present embodiment, the second display control unit 88 displays the face deforming screen image 70 on the monitor 32. In the face deforming screen image 70 (in the deformed result space 74), a player object 46 with an auxiliary-lined face texture image mapped thereon is displayed. An auxiliary-lined face texture image is a texture image formed by drawing auxiliary lines 76 for assisting a user to readily recognize bumps and recesses formed on the face 50 of a player object 46 on a face texture image 60.

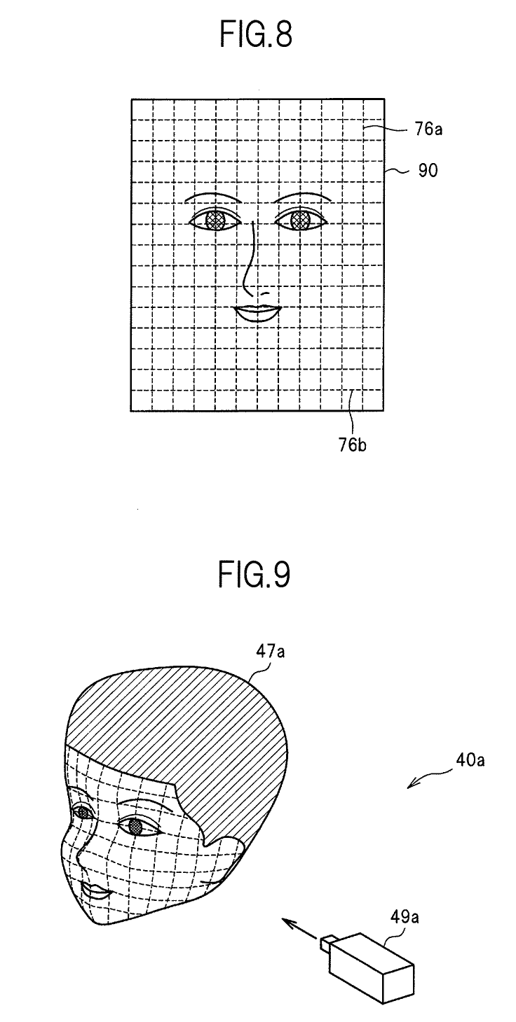

FIG. 8 is a diagram showing one example of an auxiliary-lined face texture image. The auxiliary-lined face texture image 90 shown in FIG. 8 is a texture image formed by rendering a plurality of auxiliary lines 76a, 76b forming a mesh on a face texture image 60. An auxiliary line 76a is a straight line in parallel to the portrait direction (the Y direction in FIG. 5) of a face texture image 60, extending from upper to lower ends in the face texture image 60; an auxiliary line 76b is a straight line in parallel to the landscape direction (the X direction in FIG. 5) of the face texture image 60, extending from left to right ends in the face texture image 60. The auxiliary lines 76a are rendered with a constant interval; the auxiliary lines 76b also are rendered with a constant interval. The auxiliary line 76a intersects the auxiliary line 76b by a right angle, with a rectangular mesh resultantly shown on the auxiliary-lined face texture image 90. Note that the interval of auxiliary lines 76a may be different from that of auxiliary lines 76b, and that the interval of auxiliary lines 76a and that of auxiliary lines 76b may not be constant.

Note that lower-rightward diagonal lines or upper-rightward diagonal lines, instead of the auxiliary lines 76a, 76b, may be drawn as auxiliary lines 76 on an auxiliary-lined face texture image 90. For example, a plurality of straight lines in parallel to the straight line connecting the upper left vertex 60a and the lower left vertex 60d of a face texture image 60 and a plurality of straight lines in parallel to the straight line connecting the lower left vertex 60c and the upper right vertex 60b of the face texture image 60 may be drawn on an auxiliary-lined face texture image 90.

Alternatively, for example, three or more kinds of auxiliary lines 76 may be drawn on an auxiliary-lined face texture image 90. Specifically, e.g., a plurality of straight lines in parallel to the straight line connecting the upper left vertex 60a and the lower right vertex 60d of a face texture image 60, a plurality of straight lines in parallel to the straight line connecting the lower left vertex 60c and the upper right vertex 60b of the face texture image 60, and a plurality of straight lines in parallel to the landscape direction (the X direction shown in FIG. 5) of the face texture image 60 may be drawn as auxiliary lines 76 on an auxiliary-lined face texture image 90.

In the present embodiment, the second display control unit 88 includes an auxiliary-lined texture image obtaining unit 89 for obtaining an auxiliary-lined texture image.

For example, the auxiliary-lined texture image obtaining unit 89 produces an auxiliary-lined texture image, based on an original texture image. Specifically, the auxiliary-lined texture image obtaining unit 89 renders a plurality of auxiliary lines forming a mesh 76 on an original texture image to thereby produce an auxiliary-lined texture image. For example, the auxiliary-lined face texture image 90 shown in FIG. 8 is produced as below. That is, initially, the auxiliary-lined texture image obtaining unit 89 reads a face texture image 60 from the original texture image storage unit 82, and then draws a plurality of parallel auxiliary lines 76a and a plurality of parallel auxiliary lines 76b intersecting the auxiliary lines 76a on the face texture image 60 to thereby produce an auxiliary-lined face texture image 90.

In order to display the face deforming screen image 70 (the deformed result space 74), a virtual three dimensional space different from the virtual three dimensional space 40 for a main game screen image (see FIG. 2) is created in the main memory 16. FIG. 9 is a diagram showing one example of a virtual three dimensional space for a face deforming screen image 70. As shown in FIG. 9, the head portion 47a of a player object 46 and a virtual camera 49a are placed in the virtual three dimensional space 40a for a face deforming screen image 70. In this case, the head portion 47a of the player object 46 has a shape based on deformed shape data (or deforming parameter data), and also an auxiliary-lined face texture image 90 mapped thereon. The second display control unit 88 displays an image showing a picture obtained by viewing the head portion 47a of the player object 46 from the virtual camera 49a in the deformed result space 74.

The second display control unit 88 changes the position of the virtual camera 49a in response to a user operation. For example, the distance between the head portion 47a of a player object 46 and the virtual camera 49a is changed in response to a user operation. In the present embodiment, while the position of the head portion 47a of a player object 46 is fixed, the virtual camera 49a moves farther or closer with respect to the head portion 47a in response to a user operation, whereby the distance between the head portion 47a and the virtual camera 49a is changed. Specifically, for example, in response to a user operation for instructing enlargement, the distance between the head portion 47a and the virtual camera 49a becomes shorter, as a result of which the head portion 47a (face 50) of the player object 46 is shown in an enlarged manner in the deformed result space 74. Meanwhile, for example, in response to a user operation for instructing size reduction, the distance between the head portion 47a and the virtual camera 49a becomes longer, as a result of which the head portion 47a (face 50) of the player object 46 is shown in a size-reduced manner in the deformed result space 74.

The auxiliary-lined texture image obtaining unit 89 may control the interval (mesh fineness) of the auxiliary lines 76 shown on an auxiliary-lined texture image, based on the position of the virtual camera 49a. A structure for controlling the interval of auxiliary lines 76 (mesh fineness), based on the position of the virtual camera 49a will be described below.

That is, initially, the auxiliary-lined texture image obtaining unit 89 stores interval control data for determining the interval of auxiliary lines 76, based on the position of the virtual camera 49a. Interval control data is data correlating the position of the virtual camera 49a and the interval of auxiliary lines 76. That is, for example, interval control data is data correlating a condition concerning the position of the virtual camera 49a and the interval of auxiliary lines 76. A “condition concerning the position of the virtual camera 49a” refers to a condition concerning, e.g., a distance between a player object 46 and the virtual camera 49a. In particular, a “condition concerning the position of the virtual camera 49a” for a case, as in the present embodiment, in which the position of the head portion 47a of a player object 46 is fixed, may be, e.g., a condition concerning in which of the plurality of areas set in the virtual three dimensional space 40a the virtual camera 49a is located. For example, the interval control data may be set such that auxiliary lines 76 have a relatively wider interval (a relatively rough mesh resulted) when the distance between the head portion 47a of a player object 46 and the virtual camera 49a is relatively long, and a relatively narrow interval (a relatively fine mesh resulted) when the distance between the head portion 47a of a player object 46 and the virtual camera 49a is relatively short. The interval control data may be data in a table format or an operation expression format, and stored as a part of a program.

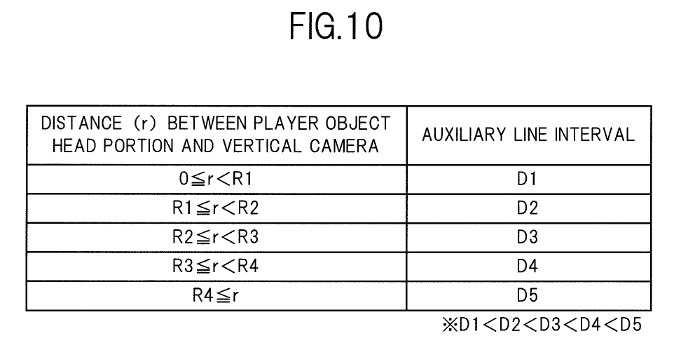

FIG. 10 shows one example of interval control data. The interval control data shown in FIG. 10 is data correlating the interval of auxiliary lines 76 and the distance between the head portion 47a of a player object 46 and the virtual camera 49a. In FIG. 10, D1 to D5 hold a relationship as D1<D2<D3<D4<D5. According to the interval control data shown in FIG. 10, for example, a wider interval (or rough mesh) is resulted for the auxiliary lines 76a, 76b shown on an auxiliary-lined face texture image 90 as the distance between the head portion 47a and the virtual camera 49a becomes longer, and a narrow interval (or fine mesh) is resulted for the auxiliary lines 76a, 76b as the distance becomes shorter.

The auxiliary-lined texture image obtaining unit 89 obtains an interval corresponding to the current position of the virtual camera 49a, based on the interval control data, and then renders auxiliary lines 76 on an original texture image, based on the obtained interval, to thereby produce an auxiliary-lined texture image.

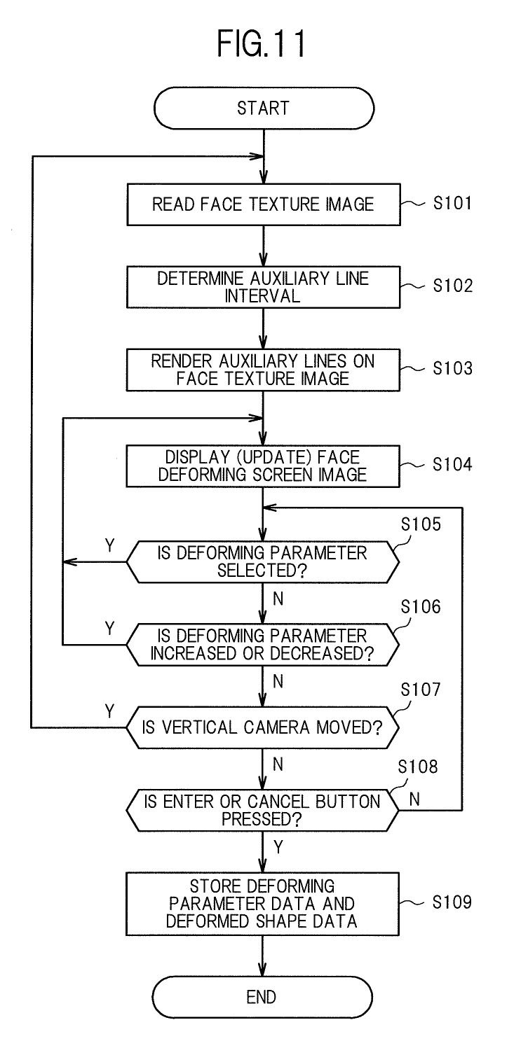

Below, a process to be carried out by the game device 10 will be described. FIG. 11 is a flowchart of a process carried out in the game device 10 to display a face deforming screen image 70. The microprocessor 14 carries out the process shown in FIG. 11 according to a program recorded on the optical disk 36.

As shown in FIG. 11, the microprocessor 14 (the auxiliary-lined texture image obtaining unit 89) reads a face texture image 60 from the optical disk 36 into the VRAM (S101), and determines the interval of auxiliary lines 76a, 76b, based on the current position of the virtual camera 49a (S102). Specifically, for example, interval control data (see FIG. 10) is read from the optical disk 36, and an interval corresponding to the current position of the virtual camera 49a is obtained, based on the read interval control data. That is, an interval corresponding to the distance between the head portion 47a of a player object 46 and the virtual camera 49a is obtained, based on the interval control data.

After determination of the intervals of respective auxiliary lines 76a, 76b, the microprocessor 14 (the auxiliary-lined texture image obtaining unit 89) renders auxiliary lines 76a, 76b on a face texture image 60 read into the VRAM (S103). That is, a plurality of auxiliary lines 76a in parallel to the portrait direction (the Y direction in FIG. 5) of the face texture image 60 are rendered with the interval determined at S102, and moreover, a plurality of auxiliary lines 76b in parallel to the landscape direction (the X direction in FIG. 5) of the face texture image 60 are rendered with the interval determined at S102. That is, through the process at S101 to S103, an auxiliary-lined face texture image 90 is rendered in the VRAM.

Thereafter, the microprocessor 14 and the image processing unit 18 (the second display control unit 88) display the face deforming screen image 70 on the monitor 32 (S104). Specifically, for example, a part of the face deforming screen image 70 other than the deformed result space 74 is rendered in the VRAM. Then, an image showing a picture obtained by viewing from the virtual camera 49a the virtual three dimensional space 40a for a face deforming screen image 70 is produced, and then rendered in the deformed result space 74 in the face deforming screen image 70 rendered in the VRAM. Note that when deformed shape data is stored in the hard disk 26, the head portion 47a of the player object 46 placed in the virtual three dimensional space 40a is set to have a shape described by the deformed shape data, while when no deformed shape data is stored in the hard disk 26, the head portion 47a of a player object 46 is set to have a basic shape (the initial state). Further, the auxiliary-lined face texture image 90 produced through the process at S101 to S103 is mapped onto the head portion 47a of the player object 46. The face deforming screen image 70 produced in the VRAM as described above is displayed on the monitor 32.

When the face deforming screen image 70 is displayed, the microprocessor 14 determines whether or not a deforming parameter selection operation has been carried out (S105). In the present embodiment, whether or not an operation for designating an upper or lower direction has been carried out is determined. If it is determined that a deforming parameter selection operation has been carried out, the microprocessor 14 updates the face deforming screen image 70 (S104). In this case, a deforming parameter to be changed is switched to another deforming parameter in response to an instruction by a user, and the deforming parameter having just been switched to is distinctly displayed in the deforming parameter space 72.

Meanwhile, if it is determined that a deforming parameter selection operation has not been carried out, the microprocessor 14 determines whether or not an operation for increasing/decreasing a deforming parameter value has been carried out (S106). In the present embodiment, whether or not an operation for designating a right or left direction has been carried out is determined. If it is determined that an operation for increasing/decreasing a deforming parameter value has been carried out, the microprocessor 14 updates the face deforming screen image 70 (S104). In this case, the value of a deforming parameter to be changed is increased/decreased as instructed by a user, and the value of the deforming parameter to be changed, the value displayed in the deforming parameter space 72 is updated. Further, in this case, the shape of the head portion 47a of the player object 46 is updated, based on the respective deforming parameter values displayed in the deforming parameter space 72. Still further, an image showing a picture obtained by viewing the virtual three dimensional space 40a from the virtual camera 49a is produced again, and displayed in the deformed result space 74. In this case, the auxiliary-lined face texture image 90 produced in the process at S101 to S103 and stored in the VRAM is mapped onto the head portion 47a of the player object 46a.

Meanwhile, if it is determined that an operation for increasing/decreasing a deforming parameter value has not been carried out, the microprocessor 14 then determines whether or not an operation for moving the virtual camera 49a has been carried out (S107). If it is determined that an operation for moving the virtual camera 49a has been carried out, the position of the virtual camera 49a is updated according to an instruction by a user. Then, the microprocessor 14 carries out again the process at S101 and thereafter to produce again an auxiliary-lined face texture image 90. Specifically, a face texture image 60 is read again from an optical disk 36 into the VRAM (S101), and the interval of auxiliary lines 76a, 76b is determined again, based on the updated position of the virtual camera 49a (S102). Then, auxiliary lines 76a, 76b are rendered with the determined interval again on the face texture image 60 (S103), whereby an auxiliary-lined face texture image 90 is produced in the VRAM. Further, the face deforming screen image 70 is updated, based on the updated position of the virtual camera 49a and the auxiliary-lined face texture image 90 produced again in the VRAM (S104).

If it is determined that an operation for moving the virtual camera 49a has not been carried out, the microprocessor 14 then determines whether not either an enter button or a cancel button has been designated (S108). If it is determined that neither an enter button nor a cancel button has been designated, the microprocessor 14 carries out the process at S105 again. Meanwhile, if it is determined that either an enter button or a cancel button has been designated, the microprocessor 14 stores deforming parameter data and deformed shape data in the hard disk 26 (S109). The data is referred to in production of a main game screen image.

In the above described game device 10, a user can desirably change the face 50 of a player object 46, using the face deforming function (the face deforming screen image 70). More particularly, in the game device 10, a user trying to change the face 50 of a player object 46 can relatively readily recognize bumps and recesses formed on the face 50 of a player object 46, while being assisted by the mesh (auxiliary lines 76a, 76b). That is, a technical problem with a user interface such that a user cannot readily recognize bumps and recesses formed on the face 50 of a player object 46 is solved. Note that, in the game device 10, a mesh, rather than simple lines, is shown on the face 50 of a player object 46 to assist a user to readily recognize bumps and recesses formed on the face 50 of a player object 46.

Here, as a method for assisting a user to readily recognize bumps and recesses formed on the face 50 of a player object 46, there is available a method for displaying an image of the head portion 47 of a player object 46 with a face texture image 60 mapped intact thereon in the deformed result space 74 and additionally displaying a wire frame of the head portion 47 on the image. However, this method, when employed, is expected to cause the following inconvenience. That is, for a player object 46 comprising many polygons, an increased processing load may result as a load in a process for displaying a wire frame is relatively large. Further, if a user changes a deforming parameter value, the wire frame needs to be displayed again. Still further, for a player object 46 comprising many polygons, lines for the wire frame are so densely located that a user may not be able to readily recognize bumps and recesses formed on the face 50 of such a player object 46.

Regarding these points, according to the game device 10, occurrence of the above described inconvenience can be avoided. That is, in the game device 10, a relatively simple process of mapping an auxiliary-lined face texture image 90 on a player object 46 is carried out, the auxiliary-lined face texture image 90 being an image formed by drawing auxiliary lines 76a, 76b on an original face texture image 60. Moreover, even though a user changes a deforming parameter, it is unnecessary to display an auxiliary-lined face texture image 90 again (see S106 in FIG. 11). That is, according to the game device 10, a process load can be reduced. Further, in the game device 10, auxiliary lines 76a, 76b can be prevented from being densely placed even for a player object comprising many polygons, by a game creator setting an appropriate interval for the auxiliary lines 76a, 76b.

In the game device 10, with employment of a method for mapping an auxiliary-lined face texture image 90 onto a player object 46, a shadow is caused for auxiliary lines 76a, 76b due to a light source, similar to the eye 52 and nose 54, or the like, of a player object 46. As a result, a user can readily recognize bumps and recesses formed on the face 50 of the player object 46.

Further, in the game device 10, the interval of auxiliary lines 76a, 76b is adjusted, based on the position of the virtual camera 49a. If the interval of auxiliary lines 76a, 76b is kept constant irrespective of the position of the virtual camera 49a, the interval of the auxiliary lines 76a, 76b shown in the deformed result space 74 may possibly result in being too wide as the virtual camera 49a moves closer to the head portion 47a of a player object 46, and too narrow as the virtual camera 49a moves farther from the head portion 47a of a player object 46. This may resultantly make it harder for a user to recognize bumps and recesses formed on the face 50 of a player object 46. Regarding this point, according to the game device 10, occurrence of the above described inconvenience can be prevented.

Further, in the game device 10, it is unnecessary, for example, to store an auxiliary-lined face texture image 90 in advance as an auxiliary-lined face texture image 90 is produced based on an original face texture image 60. Specifically, for example, even for a structure in which the interval of auxiliary lines 76a, 76b is changed based on the position of the virtual camera 49a, it is unnecessary to store in advance a plurality of auxiliary-lined face texture images 90 with auxiliary lines 76a, 76b having different intervals. As described above, according to the game device 10, a data amount can be reduced.

Note that the present invention is not limited to the above-described embodiments.

For example, a line drawn as an auxiliary line 76 on an auxiliary-lined texture image may be a line other than a straight line. That is, for example, a curved line, a wavy line, or a bent line may be drawn as an auxiliary line 76 as long as such a line can assist a user in readily recognizing bumps and recesses of an object. Further, for example, the shape of a mesh drawn on an auxiliary-lined texture image may be other than rectangular. That is, the mesh may have any shape as long as the mesh in such a shape can assist a user in readily recognizing bumps and recesses of an object. Still further, the shape of a mesh drawn on an auxiliary-lined texture image may not be constant. That is, every mesh may have a different shape.

For example, the second display control unit 88 may change the color of an auxiliary line 76, based on an original texture image. In the following, a structure for changing the color of an auxiliary line 76, based on an original texture image, will be described.

For example, the auxiliary-lined texture image obtaining unit 89 stores color control data for determining the color of an auxiliary line 76 based on an original texture image. The color control data is data correlating a condition concerning an original texture image and color information concerning the color of an auxiliary line 76. A “condition concerning an original texture image” may be a condition concerning, for example, identification information of an original texture image, or a condition concerning the color of an original texture image. A “condition concerning the color of an original texture image” is a condition concerning a statistical value (e.g., an average) of the color values of respective pixels for an original texture image. In this case, the above-described color control data is referred to, and color information corresponding to a condition satisfied by an original texture image is obtained. Then, a plurality of auxiliary lines 76 are rendered on an original texture image in the color based on the color information, whereby an auxiliary-lined texture image is produced. In the above described manner, the color of an auxiliary line 76 can be set in consideration of an original texture image. As a result, a user can be assisted to be able to readily recognize the auxiliary line 76.

For example, a user can designate a reference color of an original texture image. Specifically, a user can designate in the face deforming screen image 70 skin color (reference color) of a player object 46. In this case, a plurality of face texture images 60 having different skin colors may be stored in advance, so that a face texture image 60 corresponding to the color designated by a user may be used. Alternatively, the color (skin color) of a face texture image 60 may be updated, based on the color designated by a user, and the updated face texture image 60 may be thereafter used.

According to this aspect, the color of an auxiliary line 76 may be changed, based on the color designated by a user. In this case, color control data correlating a face texture image 60 and color information concerning the color of an auxiliary line 76 may be stored. Alternatively, color control data correlating a color available for designation by a user as skin color and color information concerning the color of an auxiliary line 76 may be stored. Then, color information corresponding to a face texture image 60 corresponding to the color designated by a user, or color information corresponding to the color designated by a user is obtained, and auxiliary lines 76a, 76b may be drawn on a face texture image 60 in the color based on the color information. In the above described manner, even for a structure for allowing a user to designate skin color of a player object 46 (that is, a structure for allowing a user to designate a reference color of an original texture image), the auxiliary lines 76 can be prevented from becoming barely recognizable.

For example, the auxiliary-lined texture image obtaining unit 89 may change the interval of auxiliary lines 76 (mesh fineness) for each of the plurality of areas set in an original texture image (an auxiliary-lined texture image). Specifically, for example, the interval of auxiliary lines 76a and/or the interval of auxiliary lines 76b may be changed for each of the plurality of areas set in a face texture image 60 (an auxiliary-lined face texture image 90). In the following, a structure for changing the intervals of auxiliary lines (mesh fineness) for each area will be described.

For example, a game creator sets in advance a significant area and an insignificant area in a face texture image 60. A “significant area” refers to an area on the face 50 of a player object 46 where bumps and recesses which a game creator thinks should be particularly distinct are formed. For example, an area having a changeable shape in the face 50 of a player object 46 is set as a significant area. More specifically, an area related to a deforming parameter is set as a significant area. For example, an area related to the “eye” parameter (an area near the eye 62), an area related to the “nose” parameter (an area near the nose 64), and so forth, are set as a significant area. Alternatively, only an area related to a deforming parameter selected to be changed (a deforming parameter being distinctly displayed) may be determined as a significant area. Still alternatively, a user may be allowed to designate a significant area. Information specifying a significant area is recorded on the optical disk 36 or in the hard disk 26.

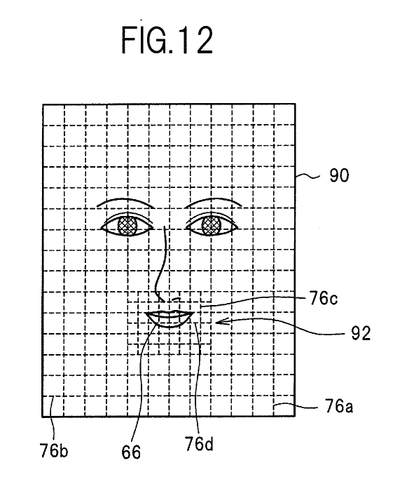

A smaller interval is set for auxiliary lines 76 in a significant area than that in an insignificant area. FIG. 12 shows one example of an auxiliary-lined face texture image 90 which is used when an area related to the “mouth” parameter, or an area around the mouth 66, is set as a significant area 92. As shown in FIG. 12, the interval of auxiliary lines 76 (auxiliary lines 76a to 76d) drawn in the significant area 92 is narrower, compared to that in other areas (an insignificant area), as a result, the mesh drawn in the significant area 92 is finer, compared to that in other areas (an insignificant area). This auxiliary-lined face texture image 90 is produced, for example, as described below. That is, auxiliary lines 76a, 76b are drawn over the entire area of the face texture image 60 with constant interval, auxiliary lines 76c are thereafter drawn between the auxiliary lines 76a in the significant area 92, and auxiliary lines 76d are additionally thereafter drawn between the auxiliary lines 76b in the significant area 92. The auxiliary line 76c is a straight line parallel to the auxiliary line 76a, and the auxiliary line 76d is a straight line parallel to the auxiliary line 76b. Note that the auxiliary lines 76c, 76d exclusively drawn in a significant area 92 may be drawn first, followed by drawing of auxiliary lines 76a, 76b in the entire area of the face texture image 60. A line (e.g., a diagonal line) other than a line parallel to the auxiliary lines 76a, 76b may be added in a significant area 92. A significant area 92 may have a shape other than rectangular. According to the auxiliary-lined face texture image 90 shown in FIG. 12, a user can more readily recognize bumps and recesses formed on an area near the mouth 66.

In the above described manner, it is possible to assist a user to more readily recognize bumps and recesses formed in, for example, a relatively significant area. Note that in this aspect as well, the interval of auxiliary lines 76 (mesh fineness) in each area is changed, based on the position of the virtual camera 49a.

Further, for example, a method other than a method for rendering auxiliary lines 76 (a mesh) on an original texture image may be employed.

For example, an auxiliary line texture image where auxiliary lines 76 alone are drawn may be stored in advance, and the second display control unit 88 may display on the monitor 32 an image showing a picture obtained by viewing, from a viewpoint, an object with an original texture image and an auxiliary line texture image, both mapped thereon, one on the other. In other words, an image showing a picture obtained by viewing an object with an auxiliary-lined texture image mapped thereon from a viewpoint may be displayed on the monitor 32, the auxiliary-lined texture image being formed by combining (synthesizing) an original texture image and an auxiliary line texture image. As described above, for example, the auxiliary-lined texture image obtaining unit 89 may combine a face texture image 60 and an auxiliary line texture image with auxiliary lines 76a, 76b (or auxiliary lines 76a to 76d) alone drawn thereon, in a semi-transparent manner, to thereby produce the auxiliary-lined face texture image 90.

Also, for example, an auxiliary-lined texture image may be stored in advance in the game data storage unit 80, and the auxiliary-lined texture image obtaining unit 89 may read the auxiliary-lined texture image from the game data storage unit 80, to thereby obtain the auxiliary-lined texture image.

Note that according to these aspects as well, the interval of auxiliary lines 76 (mesh fineness) may be changed, based on the position of a viewpoint (the virtual camera 49a). In this structure, a plurality of auxiliary line texture images (or an auxiliary-lined texture image) with auxiliary lines 76 drawn thereon with different intervals (mesh fineness) may be stored in advance. Further, a condition concerning a viewpoint position may be stored so as to be correlated to a respective auxiliary line texture image (or an auxiliary-lined texture image). An auxiliary line texture image (or an auxiliary-lined texture image) correlated to a condition satisfied by the current viewpoint position may be used.

Further, for example, according to these aspects as well, the color of an auxiliary line 76 (mesh) may be changed, based on an original texture image. In this case, a plurality of auxiliary line texture images (or an auxiliary-lined texture image) with auxiliary lines 76 (a mesh) in different colors are stored in advance. A condition concerning an original texture image is correlated to a respective auxiliary line texture image (or an auxiliary-lined texture image). An auxiliary line texture image (or an auxiliary-lined texture image) correlated to a condition satisfied by the original texture image is used. Note that according to these aspects as well, the color of an auxiliary line 76 (a mesh) may be changed, based on the skin color designated by a user. In this case, for example, a face texture image 60 is correlated to a respective auxiliary line texture image (or an auxiliary-lined texture image). An auxiliary line texture image (or an auxiliary-lined texture image) correlated to a face texture image 60 corresponding to the color designated by a user is used. Alternatively, a color available for skin color designation by a user is correlated to a respective auxiliary line texture image (or an auxiliary-lined texture image). An auxiliary line texture image (or an auxiliary-lined texture image) correlated to the color designated by a user is used.

For example, an auxiliary-lined texture image may be an image formed by drawing a plurality of parallel auxiliary lines 76 on an original texture image. For example, in the auxiliary-lined face texture image 90 shown in FIG. 8, either the auxiliary lines 76a or the auxiliary lines 76b may be omitted. In the above described manner as well, it is possible to assist a user to readily recognize bumps and recesses formed on the face 50 of a player object 46.

For example, the present invention can be applied to a game other than a soccer game. Specifically, the present invention can be applied to, for example, a golf game, so that according to the present invention, a user can be assisted to readily recognize bumps and recesses formed on a golf green. Further, the present invention can be applied to an image processing device other than a game device 10. That is, the present invention can be applied whenever it is necessary to assist a user to readily recognize bumps and recesses of an object. For example, the present invention can be applied to a modeling device (modeling software) for modeling an object.

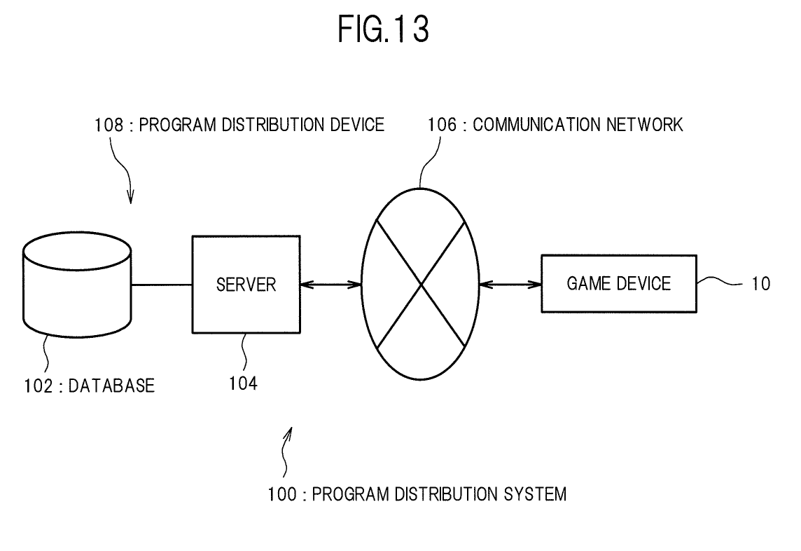

Also, for example, although a program is supplied via the optical disk 36, or an information storage medium, to the game device 10 in the above description, a program may be distributed through a communication network to the game device 10. FIG. 13 is a diagram showing an overall structure of a program distribution system utilizing a communication network. A program distribution method according to the present invention will be described, based on FIG. 13. As shown in FIG. 13, the program distribution system 100 comprises a game device 10, a communication network 106, and a program distribution device 108. The communication network 106 includes, for example, the Internet or a cable television network. The program distribution device 108 includes a database 102 and a server 104. In the system, a program similar to that which is stored in the optical disk 36 is stored in the database (an information storage medium) 102. If a demander requests program distribution, using the game device 10, the request is sent through the communication network 106 to the server 104, and the server 104, in response to the game distribution request, reads the program from the database 102 and sends to the game device 10. Note that although a program is distributed in response to a program distribution request in the above, the server 104 may send a program one-sidedly. Further, it is not always necessary to send all programs necessary to realize a game (collective distribution) at the same time, and a required program may be distributed depending on an aspect of a game (divided distribution). Game distribution via a communication network 106 as described above makes it easier for a demander to obtain a program.

1. An image processing device for displaying an image showing a picture obtained by viewing an object placed in a virtual three dimensional space from a given viewpoint, comprising:
original texture image storage means for storing an original texture image for the object; and
display control means for displaying, on display means, an image showing a picture obtained by viewing an object having an auxiliary-lined texture image mapped thereon from the viewpoint, the auxiliary-lined texture image being formed by drawing a plurality of auxiliary lines forming a mesh or a plurality of parallel auxiliary lines on the original texture image.

2. The image processing device according to claim 1, wherein
the display control means
includes auxiliary-lined texture image obtaining means for obtaining the auxiliary-lined texture image, and
displays on the display means, an image showing a picture obtained by viewing the object having the auxiliary-lined texture image mapped thereon from the viewpoint, the auxiliary-lined texture image being obtained by the auxiliary-lined texture image obtaining means.

3. The image processing device according to claim 2, wherein the auxiliary-lined texture image obtaining means produces the auxiliary-lined texture image, based on the original texture image.

4. The image processing device according to claim 3, wherein the auxiliary-lined texture image obtaining means draws the plurality of auxiliary lines forming a mesh or the plurality of parallel auxiliary lines on the original texture image to thereby produce the auxiliary-lined texture image.

5. The image processing device according to claim 4, wherein the auxiliary-lined texture image obtaining means draws at least a plurality of first auxiliary lines parallel to one another and a plurality of second auxiliary lines parallel to one another and intersecting the plurality of first auxiliary lines on the original texture image, to thereby produce the auxiliary-lined texture image.

6. The image processing device according to claim 1, wherein the display control means includes means for controlling fineness of the mesh or an interval of the plurality of auxiliary lines for each of a plurality of areas set on the auxiliary-lined texture image.

7. The image processing device according to claim 1, wherein the display control means includes means for controlling fineness of the mesh or an interval of the plurality of auxiliary lines, based on a position of the viewpoint.

8. The image processing device according to claim 1, wherein the display control means includes means for controlling a color of the plurality of auxiliary lines forming a mesh or the plurality of parallel auxiliary lines, based on the original texture image.

9. A control method for controlling an image processing device for displaying an image showing a picture obtained by viewing an object placed in a virtual three dimensional space from a given viewpoint, the method comprising:
a step of reading content stored in original texture image storage means for storing an original texture image for the object; and
a display control step of displaying, on display means, an image showing a picture obtained by viewing an object having an auxiliary-lined texture image mapped thereon from the viewpoint, the auxiliary-lined texture image being formed by drawing a plurality of auxiliary lines forming a mesh or a plurality of parallel auxiliary lines on the original texture image.

10. A program for causing a computer to function as an image processing device for displaying an image showing a picture obtained by viewing an object placed in a virtual three dimensional space from a given viewpoint, the program for causing the computer to function as:
original texture image storage means for storing an original texture image for the object; and
display control means for displaying, on display means, an image showing a picture obtained by viewing an object having an auxiliary-lined texture image mapped thereon from the viewpoint, the auxiliary-lined texture image being formed by drawing a plurality of auxiliary lines forming a mesh or a plurality of parallel auxiliary lines on the original texture image.

11. A computer readable information storage medium storing a program for causing a computer to function as an image processing device for displaying an image showing a picture obtained by viewing an object placed in a virtual three dimensional space from a given viewpoint, the program for causing the computer to function as:
original texture image storage means for storing an original texture image for the object; and
display control means for displaying, on display means, an image showing a picture obtained by viewing an object having an auxiliary-lined texture image mapped thereon from the viewpoint, the auxiliary-lined texture image being formed by drawing a plurality of auxiliary lines forming a mesh or a plurality of parallel auxiliary lines on the original texture image.
